(19) United States
(12) Patent Application Publication
(10) Pub. No.: US 2019/0345767 A1
(43) Pub. Date: Nov. 14, 2019

(54) Ladder Safety System

(71) Applicant: Kirk Heinbuch, Akron, OH (US)

(72) Inventor: Kirk Heinbuch, Akron, OH (US)

(21) Appl. No.: 15/977,057

(22) Filed: May 11, 2018

(51) Int. Cl. E06C 7/00; G08B 21/18

(52) U.S. Cl. CPC E06C 7/003; E06C 7/42; G08B 21/182

(57) ABSTRACT

A safety apparatus and system for use with a ladder. The safety apparatus comprises a lower step indicating component, a load indicating component, and an upper step indicating component. The apparatus further comprises a data storage component for storing and transmitting data generated by the lower step indicating component, the load indicating component, and the upper step indicating component.

### FIELD OF THE INVENTION

This invention pertains generally to an apparatus for improving safety when using a ladder, and more particularly to an apparatus and system for indicating when potential hazards and unsafe conditions exist while using a ladder.

### BACKGROUND

One of the most common mechanisms of injuries for ladder users is from a fall off of the ladder. The injuries can range from bruises to fractures and head injuries and even death. While falls from heights happen, many of the falls occur when an individual does not realize that they have reached the lowest step or rung of the ladder. When climbing down the ladder it can be difficult to recognize when the user reached the last or lowest step, especially if the user is carrying something or if the ladder is used in a poorly lit or unsafe environment. The user can easily lose their balance and fall if they step off the ladder believing that there are no additional steps to navigate. Accidents and injuries can also occur when the individual mistakenly believes that they are on the last step or rung and lose their balance and fall when attempting to step off the ladder from above the bottom step.

Similarly, falls from height happen when an individual does not realize that they have reached the manufacturer's maximum recommended height position on the ladder. Or users will ignore the danger of exceeding the recommended height as they stretch to finish a job that is not safe to complete from that ladder. The ladder can also become unbalanced or structurally fail in those situations as well.

Additionally, ladder users often do not realize that they have exceeded the manufacturer's maximum loaded weight capacity. While people often know their body weight, they may not know the manufacturer's maximum loaded weight capacity of the ladder. They also frequently do not take into account the additional weight of personal protective or safety equipment, work gear, tools, or supplies as they engage the ladder. This additional weight may be substantial causing an unintended excessive load that can cause the user to become unbalanced or cause the ladder itself to fail.

Consequently, there is a need for an apparatus or system that allows a user to exit a ladder safely and to alert the user when the ladder is being used in a non-recommended or unsafe manner. The present invention effectively allows a user to realize when an unsafe condition exists while using a ladder unaccompanied. The system may be incorporated into existing ladders or be integrated into newly manufactured ladders. The system can also store and transmit data related to the safe or unsafe use of the ladder.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a safety apparatus and system for use with or integrated into a ladder. The safety apparatus comprises a lower step indicating component, a load indicating component, and a data storage component. The safety apparatus may further comprise an upper step indicating component. The lower step indicating component, the load indicating component, and the upper step indicating component are electrically connected to the data storage component via a circuit.

The lower step indicating component comprises a lower sensing element attached to a bottom step of the ladder and a first indicating element. The first indicating element alerts a user when they have engaged the bottom step of the ladder. The upper step indicating component comprises an upper sensing element attached to a highest recommended climbing or standing step of the ladder and a second indicating element. The second indicating element alerts a user when they have engaged the highest recommended climbing or standing step.

The load indicating component comprises a plurality of sensors attached to each foot of the ladder, and a display element for indicating a load placed on the ladder. The load indicating component measures and displays the added load and alerts the user if the manufacturer's recommended load limit of the ladder is exceeded. The data storage component collects and stored data generated by the lower step indicating component, the load indicating component, and the upper step indicating component. The data is accessible and transmittable wirelessly.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a safety apparatus for use with a ladder in accordance with the disclosed architecture.

FIG. 2 illustrates a perspective view of a lower step indicating component of the safety apparatus for use with the ladder in accordance with the disclosed architecture.

FIG. 3 illustrates a perspective view of an upper step indicating component for the safety apparatus for use with the ladder in accordance with the disclosed architecture.

FIG. 4 illustrates an underneath perspective view of the upper step indicating component of the safety apparatus for use with a ladder in accordance with the disclosed architecture.

FIG. 5 illustrates a perspective view of the safety apparatus for use with a ladder in accordance with the disclosed architecture.

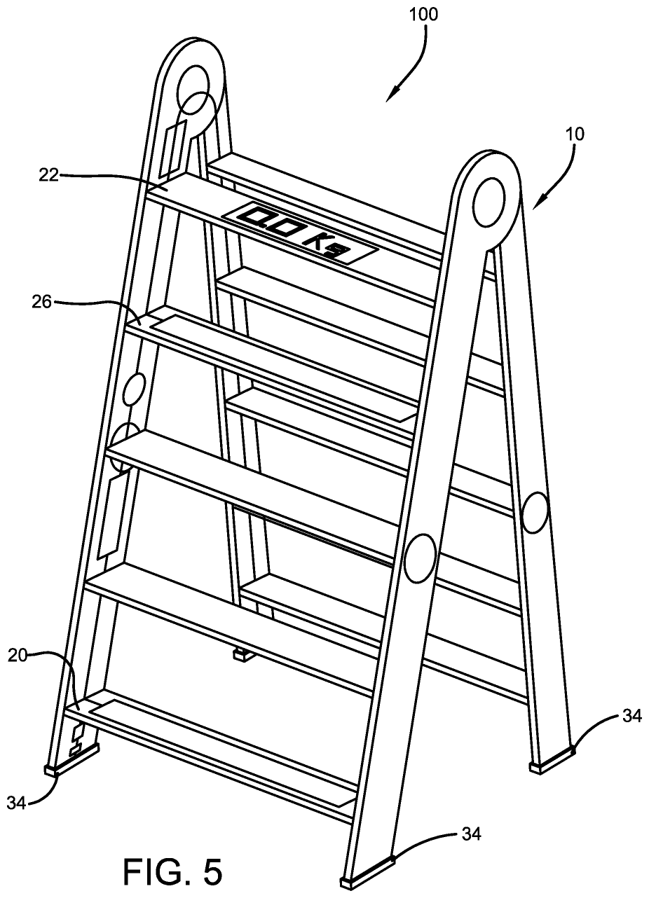

FIG. 6 illustrates a perspective view of the safety apparatus for use with a ladder in accordance with the disclosed architecture.

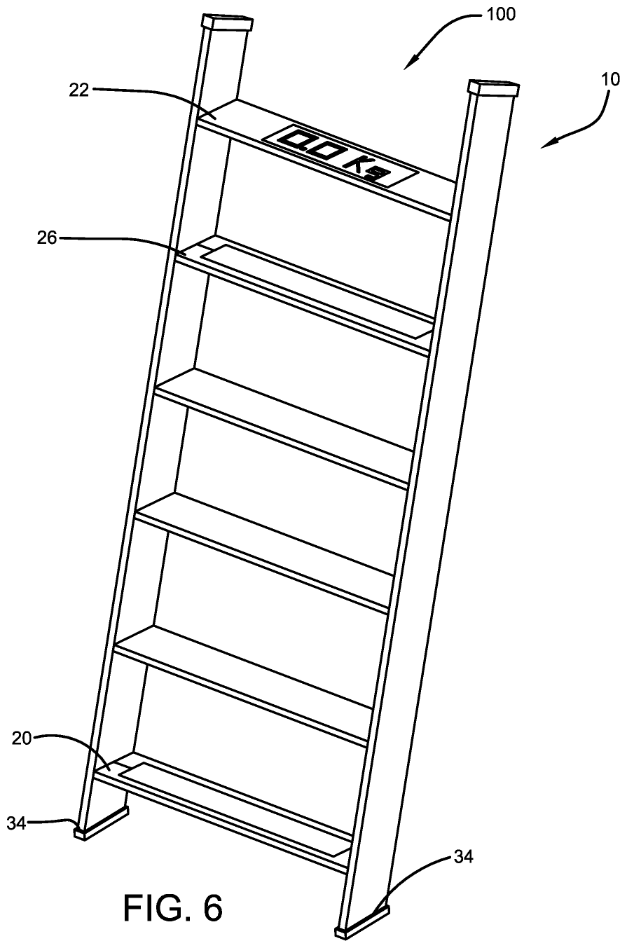

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter. The invention relates generally to a safety apparatus and system for use with or integrated into a ladder.

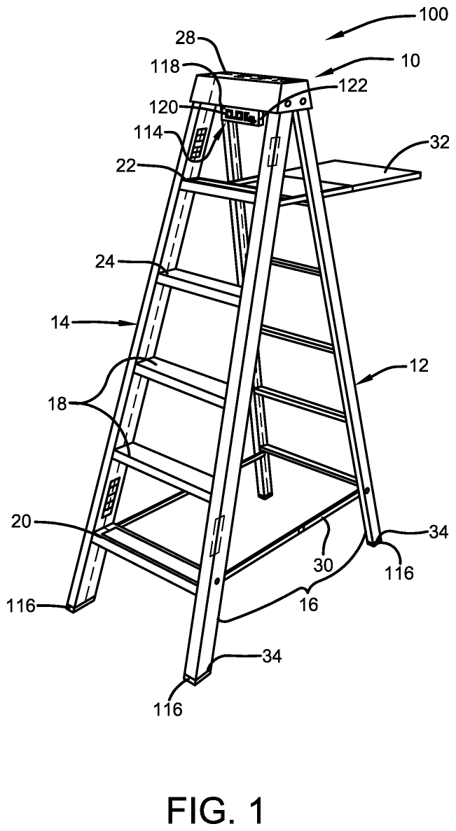

FIG. 1 illustrates a safety apparatus 100 for use with a ladder 10. The ladder 10 is generally any vertical or inclined set of rungs or steps that can be accessed by a user, such as, but not limited to, a step ladder, and A-frame ladder, a combination ladder, a fixed length ladder, an extension ladder, a bunkbed ladder, a step stool, a fire escape, scaffolding, a folding ladder, an attic ladder, or the like. The ladder 10 may comprise a climbing section 14 and a back section 12. The ladder may further comprise a plurality of rails 16 (or stringers) and a plurality of steps 18 (or rungs). The plurality of steps 18 comprise a bottom step 20, a top step 22, a second step from the top 24, and a highest recommended climbing (or standing) step 26.

The ladder 10 may further comprise a platform 28, a plurality of braces 30, a tray 32, and a plurality of feet 34. The platform 28 is typically a top of a step ladder that connects the climbing section 14 and the back section 12 via the rails 16 and is not meant as or designed to be a step. The braces 30 also connect the climbing section 14 and the back section 12 via the rails 16 at lower positions. The plurality of feet 34 is either the bottoms of the plurality of rails 16 or is an added component attached to the plurality of rails 16 for engaging the ground or surface from which the ladder will be raised.

The safety apparatus 100 comprises a lower step indicating component 102, a load indicating component 114, and a data storage component 140. The safety apparatus 100 may further comprise an upper step indicating component 126. The lower step indicating component 102, the load indicating component 114, and the upper step indicating component 126 are electrically connected to and in communication with the data storage component 140 via a circuit 144. The safety apparatus 100 may be used as an add-on system for existing ladders or may be built in or otherwise integrated within the frame of the ladder during the manufacturing process. The components may be attached to a ladder with adhesive, fasteners, hook and loop, strapping, or the like, or may be molded directly into a fiberglass, metal or composite ladder structure as a ladder with an integrated safety system.

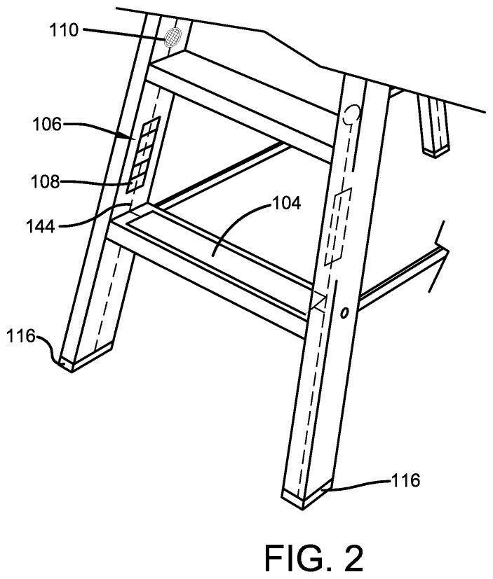

As illustrated in FIG. 2, the lower step indicating component 102 comprises a lower sensing element 104. The lower sensing element 104 is attached to or otherwise integrated into the lowest step or rung 20 of the climbing section 14 the ladder 10. The lower sensing element 104 is a pressure sensitive component such as, but not limited to, a pressure pad, a pressure mat, a pressure sensitive switch, a pressure plate, a compression mat, or the like. The lower sensing element 104 is activated when a minimum predetermined force is applied, such as when a user steps on the lower sensing element 104. The lower sensing element 104 may alternatively be integrated directly into the bottom step 20 of the ladder 10. The lower step indicating component 102 alerts the user when the bottom step 20 of the ladder 10 is engaged or stepped on by the user.

The lower step indicating component 102 further comprises a first indicating element 106 in electrical communication with the lower sensing element 104. The first indicating element 106 comprises a first visual indicator 108. The first visual indicator 108 is typically a lighting component such as a plurality of LED lighting strips or lamps. FIG. 2 illustrates a pair of LED light strips, each located on opposing rails 16 of the ladder 10. The first visual indicator 108 may be positioned on the inside or outside of the rail 16, or may be placed in any position on the ladder 10 that would maximize effectiveness. Additionally, the first visual indicator 108 may be attached to or integrated into the ladder as described for the lower sensing element 104 supra.

The first indicating element 106 may further comprise a first audible indicator 110 and a first vibrating indicator (not shown). The first audible indicator 110 is typically a plurality of speakers integrated or attached to the ladder 10 that are in electrical communication with the lower sensing element 104. The first audible indicator 110 may generate an audible alert or signal alerting the user when pressure is applied to the lower sensing element 104. Similarly, the first vibrating indicator (not shown) may vibrate to alert the user when pressure is applied to the lower sensing element 104.

The load indicating component 114 provides an indication of the load on the ladder 10 when in use. The load indicating component 114 also alerts the user when the recommended load limit of the ladder is exceeded. The load indicating component 114 comprises a plurality of foot sensors 116 and a display element 118 electrically connected to the plurality of foot sensors 116. The plurality of foot sensors 116 are integrated into or attached to the plurality of feet 34 of the ladder 10. The plurality of foot sensors 116 are pressure sensitive components or load sensors similar to the lower sensing element 104. The display element 118 comprises a numerical display 120 for indicating a weight of the added load to the ladder when in use. The display element 118 may further comprise an optical display 122 with a lighting component that can display different colors or visual cues to indicate if the load is within the ladder's recommended capacity or not.

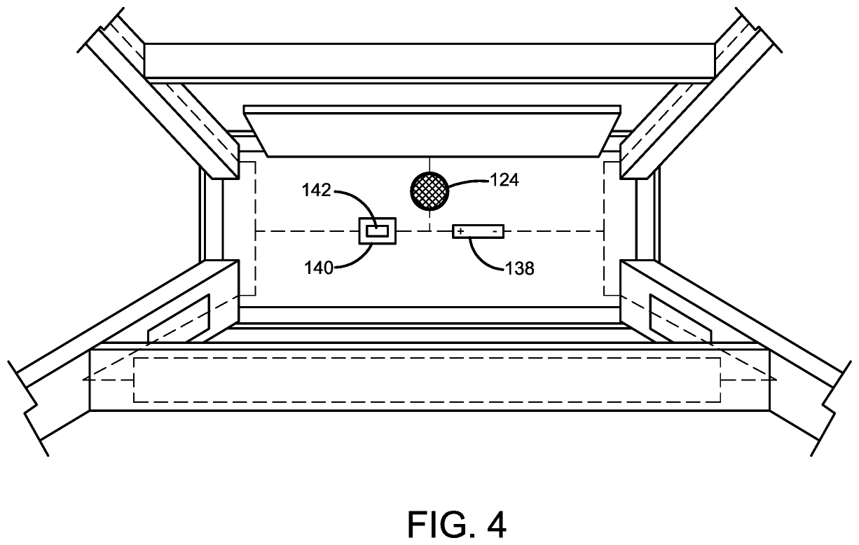

As illustrated in FIG. 4, the display element 118 may further comprise an audible display 124, such as a speaker, for audibly indicating if the load is within the ladder's recommended capacity or not. The load indicating component 114 provides continuous feedback about the load whenever the ladder 10 is in use. This is beneficial when a user initially engages the ladder 10 at a safe weight, but picks up an additional load while on the ladder 10. The load indicating component 114 would recognize the additional load in real time and alert the user if the recommended capacity was exceeded. The load indicating component 114 would alert the user no matter where they were on the ladder 10 of the unsafe condition.

Alternatively, the load indicating component 114 may be integrated into the lower sensing element 104 of the lower step indicating component 102.

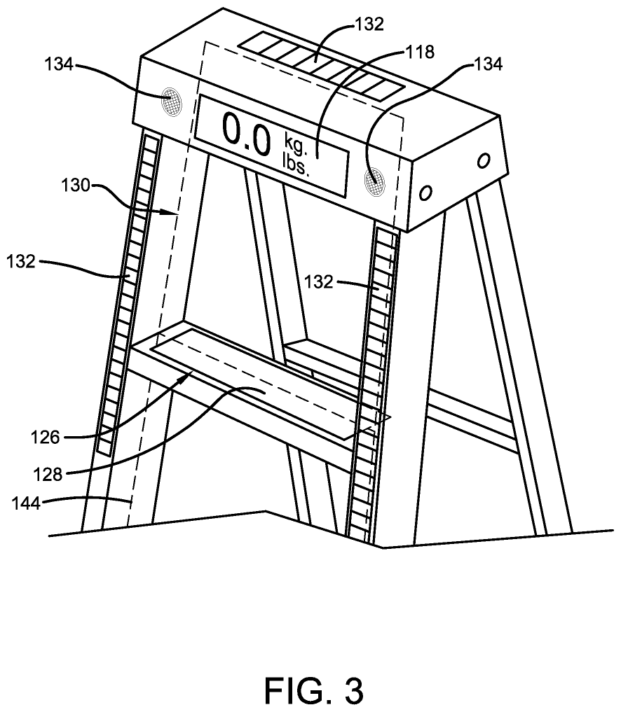

As illustrated in FIG. 3, the upper step indicating component 126 comprises an upper sensing element 128. The upper sensing element 128 may be attached to or otherwise integrated into the top step or rung 22, the second from the top step 24, or the platform 28 of the ladder 10 as desired. Preferably the upper sensing element 128 is located on or within the manufacturer's highest recommended climbing or standing step 26 of the ladder 10. The upper step indicating component 126 alerts the user when that step of the ladder 10 is engaged or stepped on by the user.

The upper sensing element 128 is a pressure sensitive component such as, but not limited to, a pressure pad, a pressure mat, a pressure sensitive switch, a pressure plate, a compression mat, or the like. The upper sensing element 128 is activated when a minimum predetermined force is applied, such as when a user steps on the upper sensing element 128. The upper sensing element 128 may alternatively be integrated directly into one of the plurality of steps 18 of the ladder 10.

The upper step indicating component 126 further comprises a second indicating element 130 in electrical communication with the upper sensing element 128. The second indicating element 130 comprises a second visual indicator 132. The second visual indicator 132 is typically a lighting component such as a plurality of LED lighting strips or lamps. FIG. 3 illustrates a pair of LED light strips, each located on opposing rails 16 of the ladder 10. The second visual indicator 132 may be positioned on the inside or outside of the rails 16, or may be placed in any position on the ladder 10 that would maximize effectiveness. Additionally, the second visual indicator 132 may be attached to or integrated into the ladder as described for the upper sensing element 128 supra. Alternatively, the second visual indicator 132 may be attached to or integrated into the platform 28 of the ladder 10 for additional visibility.

The second indicating element 130 may further comprise a second audible indicator 134 and a first vibrating indicator (not shown). The second audible indicator 134 is typically a plurality of speakers integrated or attached to the ladder 10 that are in electrical communication with the upper sensing element 128. The second audible indicator 134 may generate an audible alert or signal alerting the user when pressure is applied to the upper sensing element 128. Similarly, the first vibrating indicator (not shown) may vibrate to alert the user when pressure is applied to the upper sensing element 128.

Both the first indicating element 106 and the second indicating element 130 are interconnected. As such, all of the components could be activated simultaneously if desired. Also, the first audible indicator 110 and second audible indicator 134 could be combined as a single audible indicator or speaker.

The safety apparatus 100 further comprises a power source 138. The power source 138 is a typically at least one battery connected to the circuit 44. The power source 138 may comprise multiple batteries, capacitors, solar cells, or the like that may be attached to or integrated anywhere on or within the ladder frame. FIG. 4 illustrates the power source 138 located under the platform 28 of the ladder for protection from the weather. Alternatively, the safety apparatus 100 may be powered by a plug-in cord if desired.

The data storage component 140 comprises a communication element 142 and a memory (not shown). The data storage component 140 is electrically connected to all of the other components and receives data from the load indicating component 114. The data storage component 140 may also receive, collect, time stamp, and store information from the lower sensing element 104 and the upper step indicating element 130. Information, such as loads exceeding the manufacturer's recommended load, may be stored for later download. This allows an employer to ensure compliance with safety standards. The communication element 142 may use wireless communication, Bluetooth, RFID, or the like to transmit the information when desired.

The system allows a user to safely use a ladder. When the user has at least one foot on the lower step indicating component 102, the first indicating element 106 illuminates and or audibly activates to warn the user that they are within one step of the ground or support surface. The audible alert is desirable as the illumination may be less visible due to ambient light or an obstruction. The first indicating element 106 deactivates once both feet are either above the bottom step 20, or when the used has exited the ladder.

When the user has both feet on the bottom step 20, the display element 118 will show a digital numerical scale read out that indicates the user's weight in addition to their clothing, safety equipment, tools carried, or materials being carried up the ladder 10. If the ladders maximum weight capacity is exceeded, the display element 118 illuminates and or audibly activates to warn the user. The data storage component 140 also stores this information for later download.

When the user has at least one foot on the upper step indicating component 126, the second indicating element 130 illuminates and or audibly activates to warn the user that they are at the manufacture's maximum height position. The second indicating element 130 deactivates once both feet are below the manufacture's maximum height position.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-6. (canceled)

7. A safety apparatus for use with a ladder, the safety apparatus comprising:
a lower step indicating component comprising a first indicating element comprising a visual indicator or an audible indicator, and a lower sensing element that is pressure sensitive;
a load indicating component comprising a plurality of foot sensors that are pressure sensitive and are attached to a plurality of feet of the ladder, and a display element for indicating a weight of a load on the ladder;
an upper step indicating component comprising a second indicating element comprising a second visual indicator or a second audible indicator, and an upper sensing element that is pressure sensitive, the second indicating element triggered independently from the first indicating element;
a data storage component in electrical communication with the lower step indicating component, the load indicating component, and the upper step indicating component; and
wherein the display element comprises a numerical display and an optical display configured to display a plurality of visual cues that indicate a load status of the ladder.

8-15. (canceled)

16. A ladder safety system comprising:
a lower step indicating component comprising a lower sensing element that is pressure sensitive attached to a bottom step of a ladder, and a first indicating element comprising a visual indicator and an audible indicator;
a load indicating component comprising a plurality of foot sensors that are pressure sensitive attached to a plurality of feet of the ladder, and a display element for indicating a weight of a load on the ladder;
an upper step indicating component comprising an upper sensing element that is pressure sensitive attached a highest recommended climbing step of the ladder, and a second indicating element comprising a second visual indicator and a second audible indicator, wherein the second indicating element is triggered independently from the first indicating element;
a data storage component in electrical communication with the lower step indicating component, the load indicating component, and the upper step indicating component;
wherein the data storage component comprises a communication element for transmitting information retained by the data storage component; and
wherein the display element provided continuous feedback about a load status of the ladder, the display element comprising a numerical display and an optical display comprising a lighting component configured to display a plurality of colors that indicate whether a recommended load of the ladder has been exceeded.

17. The system of claim 16, wherein the communication element transmits the information wirelessly.

18. The system of claim 17, wherein the lower step indicating component alerts a user when the bottom step of the ladder is engaged.

19. The system of claim 18, wherein the upper step indicating component alerts a user when the highest recommended climbing step of the ladder is engaged.

20. The system of claim 19, wherein load indicating component alerts a user when a recommended load limit of the ladder is exceeded.
